(19) United States
(12) Patent Application Publication
(10) Pub. No.: US 2025/0048508 A1
(43) Pub. Date: Feb. 6, 2025

(54) INDUCTION HEATING DEVICE INCLUDING COIL BOARD

(71) Applicant: SAMSUNG ELECTRONICS CO., LTD., Suwon-si (KR)

(72) Inventor: Nobuharu NISHIKOORI, Yokohama-shi (JP)

(21) Appl. No.: 18/808,881

(22) Filed: Aug. 19, 2024

Related U.S. Application Data
(63) Continuation of application No. PCT/KR2024/095966, filed on Aug. 1, 2024.

(30) Foreign Application Priority Data
Aug. 2, 2023 (JP) 2023-126209

(51) Int. Cl. H05B 6/12; H01F 5/00

(52) U.S. Cl. CPC H05B 6/1272; H01F 5/003

(57) ABSTRACT

An induction heating device includes an inverter circuit configured to drive heating coils. The induction heating device includes a coil board including a plurality of pattern layers on which heating coils are printed to form coil patterns. The coil patterns respectively formed on the plurality of pattern layers are electrically connected to each other, a first end of the coil patterns may be connected to an input terminal, and a second end of the coil patterns may be connected to an output terminal. At least one of the coil patterns branch in parallel at a branching point located between the input terminal and the output terminal, and join at a joining point located between the input terminal and the output terminal.

### CROSS-REFERENCE TO RELATED APPLICATIONS

This application is a continuation application under, 35 U.S.C. § 111 (a), of International Patent Application No. PCT/KR2024/095966, filed on Aug. 1, 2024, which claims priority to Japanese Patent Application No. 2023-126209, filed on Aug. 2, 2023, the content of which in their entirety is herein incorporated by reference.

### BACKGROUND

The disclosure relates to a heating coil board used in an induction heating device or non-contact power supply.

Various types of heating devices for cooking are used to heat food at home or in restaurants. In the past, gas ranges fueled by gas were widely used, but recently, heating devices for cooking that use electricity instead of gas to heat an object to be heated, for example, a cooking vessel such as a pot, have been widely distributed.

Methods of heating an object to be heated by using electricity are broadly classified into resistance heating and induction heating. Resistance heating is a method of heating an object to be heated (e.g., a cooking vessel) by transmitting heat generated when current flows through a metal resistance wire or a non-metal heating element such as silicon carbide, through radiation or conduction. Induction heating is a method of generating an eddy current in an object to be heated including a metal component by using a magnetic field generated around a coil when high-frequency power with a certain magnitude is applied to the coil, such that the object is heated. Among them, induction ranges that apply induction heating generally have working coils (heating coils) respectively corresponding to a plurality of objects to be heated (cooking vessels) to heat them individually.

Induction ranges are heating devices for cooking that use the principle of induction heating, and are commonly referred to as induction cook device, induction heating device, or induction cooking device. Induction ranges do not consume oxygen and do not emit waste gas compared to gas ranges, and thus may reduce indoor air pollution and an increase in indoor temperature. In addition, induction ranges use an indirect method of inducing heat to an object to be heated itself, and have the advantages of high energy efficiency and stability, and low risk of burns because heat is generated only from the object to be heated and the contact surface is not heated, and thus, the demand for induction ranges has been continuously increasing recently.

Recently, induction ranges that allow an object to be heated to be placed anywhere on a top plate (hereinafter, referred to as ‘any-place’) have been developed. Such induction ranges enable an object to be heated to be placed in an area where a plurality of heating coils are arranged, to be inductively heated regardless of the size and location of the object to be heated.

In general, induction ranges include a heating coil around which a copper wire is wound. However, a structure in which a heating coil is printed on a board is required to improve productivity. Because a heating coil in an induction range needs to be able to conduct a large current, when manufacturing a heating coil that is printed on a board, it is necessary to precisely design the thickness and width of a pattern, a stack thickness, etc. in printing of the heating coil.

### SUMMARY

An induction heating device according to an embodiment of the disclosure includes an inverter circuit configured to drive heating coils. The induction heating device according to an embodiment of the disclosure includes a coil board including a plurality of pattern layers on which heating coils are printed to form coil patterns. According to an embodiment of the disclosure, the coil patterns respectively formed on the plurality of pattern layers may be electrically connected to each other, a first end of the coil pattern is connected to an input terminal, and a second end of the coil pattern is connected to an output terminal. According to an embodiment of the disclosure, at least one of the coil patterns branch in parallel at a branching point located between the input terminal and the output terminal, and join at a joining point located between the branching point and the output terminal.

In the induction heating device according to an embodiment of the disclosure, a first-layer coil pattern of the plurality of pattern layers may be electrically connected to a second-layer coil pattern of the plurality of pattern layers through a conductor formed in an inner part of the first-layer coil pattern.

In the induction heating device according to an embodiment of the disclosure, the second-layer coil pattern of the plurality of pattern layers may be electrically connected to a third-layer coil pattern through a conductor formed in an outer part of the second-layer coil pattern.

In the induction heating device according to an embodiment of the disclosure, the conductor may include a via hole vertically penetrating at least one of the plurality of pattern layers.

According to an embodiment of the disclosure, lengths of two or more branching paths branching in parallel at the branching point and joining at the joining point may be equivalent to each other within a difference of 5% or less.

According to an embodiment of the disclosure, in a case in which a frequency of a current flowing through the coil pattern is 50 KHz or greater, the lengths of the two or more branching paths may be equivalent to each other within a difference of 1% or less.

In the induction heating device according to an embodiment of the disclosure, when the branching paths, which are generated as the coil patterns formed on the plurality of pattern layers branch, are arranged such that a first branching path, a second branching path, . . . , and an nth branching path (where n is a natural number greater than or equal to 2) are arranged from the inner part of the first-layer coil pattern, the first branching path, the second branching path, . . . , and the nth branching path may be arranged from the outer part of the second-layer coil pattern.

In the induction heating device according to an embodiment of the disclosure, the coil board may include an adjustment path formed in the inner part or an outer part of the first-layer coil pattern, to adjust lengths of at least one of the first branching path, the second branching path, . . . , and the nth branching path.

According to an embodiment of the disclosure, a pattern layer including at least one of the coil patterns branching in parallel at the branching point may be a pattern layer other than an uppermost layer and a lowermost layer of the plurality of pattern layers of the coil board.

In the induction heating device according to an embodiment of the disclosure, the uppermost layer, which does not include the branching point, may include the input terminal or the output terminal. According to an embodiment of the disclosure, the lowermost layer, which does not include the joining point, may include the output terminal or the input terminal.

In the induction heating device according to an embodiment of the disclosure, from among the coil patterns formed on the plurality of pattern layers, a first coil pattern may branch in a first layer of the plurality of pattern layers, and a second coil pattern may branch in a second layer of the plurality of pattern layers.

In the induction heating device according to an embodiment of the disclosure, the branching point at which at least one of the coil patterns branch in parallel may be a point at which alternating-current resistance of the coil board is higher than areas where the other coil patterns are located.

In the induction heating device according to an embodiment of the disclosure, at least one of the coil patterns may branch in parallel at a plurality of branching points located between the input terminal and the output terminal as many times as the number of the plurality of branching points, and join at a plurality of joining points located between the input terminal and the output terminal as many times as the number of the plurality of joining points.

In the induction heating device according to an embodiment of the disclosure, the coil patterns of respective layers included in the plurality of pattern layers may be electrically connected to each other in series.

In the induction heating device according to an embodiment of the disclosure, the coil patterns of respective layers included in the plurality of pattern layers may be electrically connected to each other in series or in parallel.

### BRIEF DESCRIPTION OF DRAWINGS

FIG. 1A is a diagram illustrating an induction heating device according to an embodiment of the disclosure.

FIG. 1B is a diagram illustrating an any-place induction heating device according to an embodiment of the disclosure.

FIG. 1C is a diagram illustrating heating coils wound in an any-place induction heating device, according to an embodiment of the disclosure.

FIG. 1D is a circuit diagram of an induction heating device including an inverter circuit for operating a plurality of heating coils, according to an embodiment of the disclosure.

FIG. 2 is a diagram illustrating a stack structure of a coil board according to an embodiment of the disclosure.

FIG. 3 is a plan view illustrating a configuration of a coil board according to an embodiment of the disclosure.

FIG. 4 is a diagram illustrating wiring of a coil board according to an embodiment of the disclosure.

FIG. 5 is a diagram illustrating a modified example of wiring of a coil board, according to an embodiment of the disclosure.

FIG. 6 is a diagram illustrating a modified example of wiring of a coil board, according to an embodiment of the disclosure.

FIG. 7 is a diagram illustrating a modified example of wiring of a coil board including a plurality of branches and junctions, according to an embodiment of the disclosure.

FIG. 8 is a cross-sectional view illustrating interlayer connections of a coil board according to an embodiment of the disclosure.

FIG. 9 is a block diagram of an induction heating device according to an embodiment of the disclosure.

### DETAILED DESCRIPTION

Terms used herein will be briefly described, and then an embodiment of the disclosure will be described in detail.

Although the terms used herein are selected from among common terms that are currently widely used in consideration of their functions in an embodiment of the disclosure, the terms may be different according to an intention of one of ordinary skill in the art, a precedent, or the advent of new technology. Also, in particular cases, the terms are discretionally selected by the applicant of the disclosure, in which case, the meaning of those terms will be described in detail in the corresponding description of an embodiment of the disclosure. Therefore, the terms used herein are not merely designations of the terms, but the terms are defined based on the meaning of the terms and content throughout the disclosure.

As used herein, the expression “at least one of a, b, or c” may indicate only a, only b, only c, both a and b, both a and c, both b and c, all of a, b, and c, or variations thereof.

Throughout the disclosure, when a part “includes” an element, it is to be understood that the part may additionally include other elements rather than excluding other elements as long as there is no particular opposing recitation. In addition, as used herein, the terms such as “ . . . er (or)”, “ . . . unit”, “ . . . module”, etc., denote a unit that performs at least one function or operation, which may be implemented as hardware or software or a combination thereof.

Hereinafter, an embodiment of the disclosure will be described in detail with reference to the accompanying drawings to allow those of skill in the art to easily carry out the embodiment. An embodiment of the disclosure may, however, be embodied in many different forms and should not be construed as being limited to the embodiment set forth herein. Also, parts in the drawings unrelated to the detailed description are omitted to ensure clarity of an embodiment of the disclosure, and like reference numerals in the drawings denote like elements.

Induction heating devices induce a magnetic field in a heating coil to heat a cooking vessel, and the induced magnetic field causes eddy currents to flow in the cooking vessel, thereby heating the cooking vessel. Here, when the heating coil is made into a printed circuit board (PCB), assembly becomes easier and the durability of the induction heating device increases. However, when printing a heating coil on a board (PCB), a large current flows through the heating coil, which may cause the board to overheat, and in a case in which a plurality of heating coil pattern layers are formed, insulation also needs to be designed appropriately.

Thus, according to an embodiment of the disclosure, an induction heating device is disclosed including a heating coil board including a plurality of heating coil pattern layers. In the disclosure, a board may include a PCB having printed thereon a patterned circuit. When a plurality of heating coil pattern layers are stacked, an insulating layer may be arranged between them.

Related-art induction heating devices inductively heat an object to be heated by generating eddy currents on the surface of the object to be heated by flowing a current through a heating coil formed on a printed board. In this type of induction heating device, there is a need to flow a high-frequency current through the printed heating coil to improve heating efficiency or to miniaturize the coil.

However, when a high-frequency current flows through the coil, the magnetic flux is concentrated in the inner part or outer part of the coil, which causes a proximity effect to increase the alternating-current resistance, and accordingly, the loss in the inner part or outer part of the coil may increase, and the amount of heat generated due to the loss may increase.

In addition, because printed heating coils are more difficult to dissipate heat than wound heating coils, there is a risk that, for example, when heat is generated toward the inner part due to a high-frequency current, the inner diameter side may overheat, leading to a failure.

This phenomenon also occurs when a high-frequency current flows through an electromagnetic induction coil used for non-contact power supply.

Hereinafter, an electromagnetic induction coil according to an embodiment of the disclosure will be described with reference to the drawings.

An induction heating device 2000 according to the present embodiment inductively heats an object to be heated, which is a cooking tool such as a cooking pot, placed on a top plate 1, and may be configured such that an object to be heated may be freely placed anywhere on the top plate and then heated. An induction heating device capable of heating an object to be heated no matter where it is placed on the top plate is referred to as an any-place induction heating device.

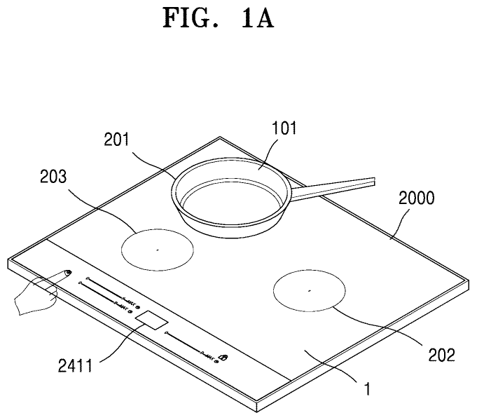

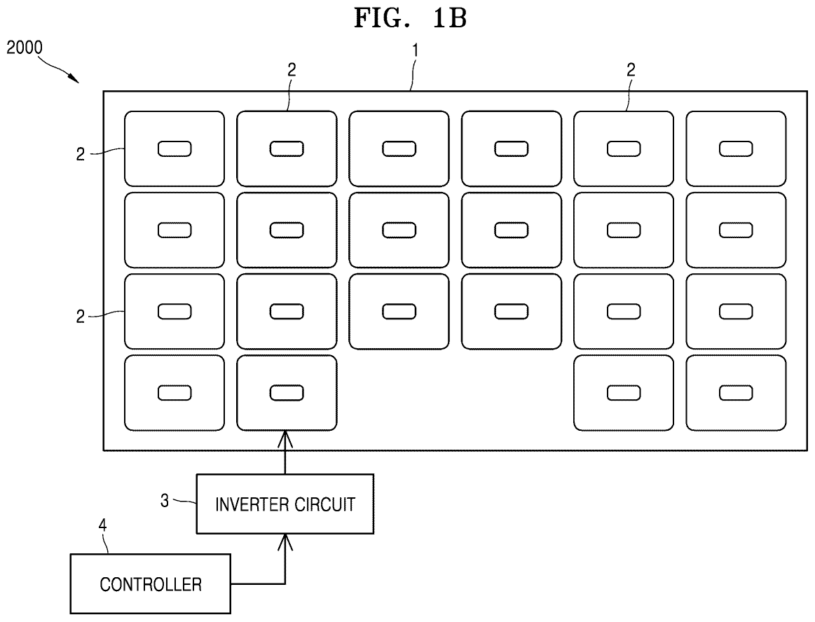

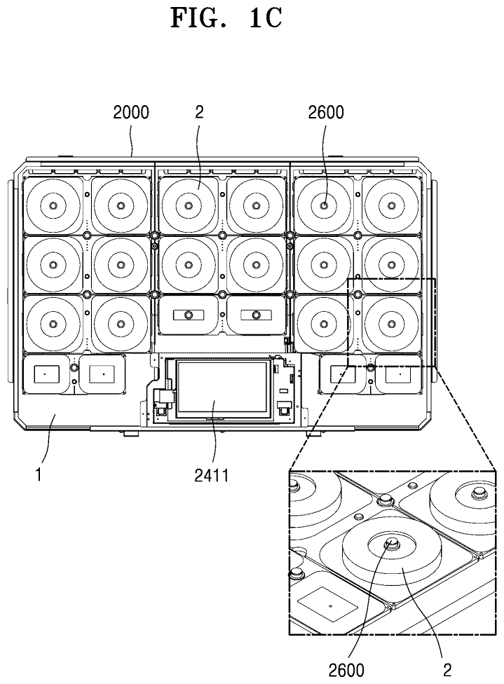

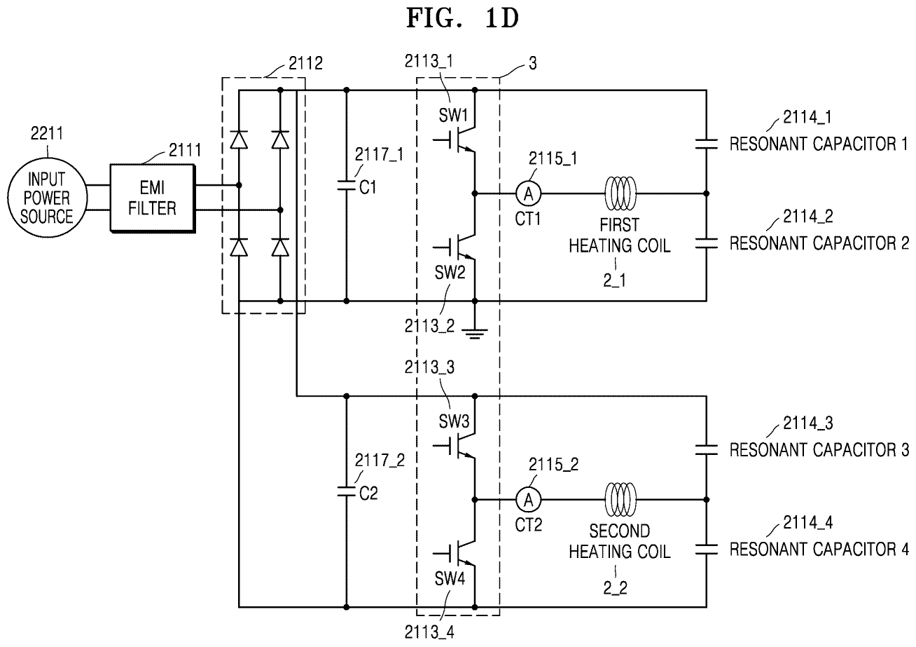

FIG. 1A is a diagram for describing an induction heating device according to an embodiment of the disclosure.

Referring to FIG. 1A, the induction heating device 2000 according to an embodiment of the disclosure may include a plurality of heating zones 201, 202, and 203. Hereinafter, the induction heating device 2000 may be referred to as an induction heating device, an induction cooking device, or simply a heating device. All of the components illustrated in FIG. 1A are not essential components. The induction heating device 2000 may be implemented with more or fewer components than the illustrated components.

A cooking vessel 101, which is an object to be heated, may be a device for heating contents inside the cooking vessel 101. The contents of the cooking vessel 101 may be liquids, such as water, tea, coffee, soup, juice, wine, oil, etc., or solids, such as butter, meat, vegetables, bread, rice, etc., but are not limited thereto.

According to an embodiment of the disclosure, the cooking vessel 101 may wirelessly receive power from the induction heating device 2000 via electromagnetic induction. Thus, the cooking vessel 101 according to an embodiment of the disclosure does not include a power cord to be connected to a power outlet.

According to an embodiment of the disclosure, the type of cooking vessel 101 that wirelessly receives power from the induction heating device 2000 may vary. The cooking vessel 101 may be a general induction heating (IH) vessel (hereinafter, referred to as ‘IH vessel’) including a magnetic material. A magnetic field may be induced in the cooking vessel 101 (IH metal) itself.

The cooking vessel 101 may be a general IH vessel such as a pot, a frying pan, or a steamer. The cooking vessel 101 may include a cooker appliance. The cooker appliance may be a device into which a typical IH vessel may be inserted or removed. According to an embodiment of the disclosure, the cooker appliance may be an appliance capable of automatically cooking contents according to a recipe. Depending on the intended use, the cooker appliance may be referred to as a pot, a rice cooker, or a steamer. For example, the cooker appliance having inserted therein an inner pot for cooking rice may be referred to as a rice cooker. Hereinafter, the cooker appliance may be defined as a smart pot.

According to an embodiment of the disclosure, in a case in which the cooking vessel 101 includes a communication interface, the cooking vessel 101 may communicate with the induction heating device 2000. The communication interface may include a short-range wireless communication interface, a long-range communication interface, and the like. The short-range wireless communication interface may include, but is not limited to, a Bluetooth communication unit, a Bluetooth Low Energy (BLE) communication unit, a near-field communication (NFC) unit, a wireless local area network (WLAN) (e.g., Wi-Fi) communication unit, a Zigbee communication unit, an Infrared Data Association (IrDA) communication unit, a Wi-Fi Direct (WFD) communication unit, an ultra-wideband (UWB) communication unit, an Ant+communication unit, and the like. In a case in which the cooking vessel 101 is remotely controlled by a server (not shown) in an internet-of-Things (IoT) environment, the long-range communication interface may be used to communicate with the server. The long-range communication interface may include the Internet, a computer network (e.g., a local area network (LAN) or a wide area network (WAN)), and a mobile communication unit. The mobile communication unit may include, but is not limited to, a 3rd Generation (3G) module, a 4th Generation (4G) module, a 5th Generation (5G) module, a Long-Term Evolution (LTE) module, a narrowband IoT (NB-IoT) module, an LTE for Machines (LTE-M) module, and the like.

According to an embodiment of the disclosure, the cooking vessel 101 may transmit information to a server (not shown) through the induction heating device 2000. For example, the cooking vessel 101 may transmit information obtained from the cooking vessel 101 (e.g., temperature information of the contents) to the induction heating device 2000 through short-range wireless communication (e.g., Bluetooth or BLE). Here, the induction heating device 2000 may transmit information obtained from the cooking vessel 101 to a server by connecting to the server by using a WLAN (Wi-Fi) communication unit or a long-range communication unit (e.g., the Internet). In addition, the server may provide a user with the information obtained from the cooking vessel 101 received from the induction heating device 2000 through a mobile terminal (not shown) connected to the server. According to an embodiment of the disclosure, the induction heating device 2000 may directly transmit the information obtained from the cooking vessel 101 to the mobile terminal of the user through device-to-device (D2D) communication (e.g., WFD communication or BLE communication).

In addition, according to an embodiment of the disclosure, the cooking vessel 101 may directly transmit information of the cooking vessel 101 (e.g., temperature information of contents) to the server through a communication interface (e.g., a WLAN (Wi-Fi) communication unit). In addition, the cooking vessel 101 may directly transmit information obtained from the cooking vessel 101 (e.g., temperature information of contents or material information of the cooking vessel) to a mobile device of the user through short-range wireless communication (e.g., Bluetooth or BLE) or D2D communication. In an embodiment, the cooking vessel 101 may directly transmit information obtained from the cooking vessel 101 (e.g., temperature information of contents or material information of the cooking vessel) to a controller (not shown) of the induction heating device 2000 through short-range wireless communication (e.g., Bluetooth or BLE) or D2D communication.

The induction heating device 2000 according to an embodiment of the disclosure may be a device that wirelessly transmits power to the cooking vessel 101 located on the top plate 1 of the induction heating device 2000 by using electromagnetic induction. The induction heating device 2000 may include a working coil that generates a magnetic field for inductively heating the cooking vessel 101. The working coil is a coil for generating a magnetic field through the flow of electricity, and may also be referred to as a heating coil throughout the disclosure.

Generating a magnetic field by a heating coil may include transmitting power by using a magnetic field induced in an IH metal (e.g., iron) by using a magnetic induction method. For example, the induction heating device 2000 may cause an eddy current to be generated in the cooking vessel 101 by flowing a current through the heating coil to form a magnetic field.

According to an embodiment of the disclosure, the induction heating device 2000 may include a plurality of heating coils. For example, in a case in which the top plate 1 of the induction heating device 2000 includes a plurality of cooking zones, the induction heating device 2000 may include a plurality of heating coils corresponding to the plurality of cooking zones, respectively. In addition, the induction heating device 2000 may include a high-power cooking zone having a first heating coil provided on the inner side and a second heating coil provided on the outer side. The high-power cooking zone may include two or more heating coils.

The top plate 1 of the induction heating device 2000 according to an embodiment of the disclosure may be made of reinforced glass such as ceramic glass so as not to be easily broken. In addition, the top plate 1 of the induction heating device 2000 may include a guide mark for guiding through a cooking zone where the cooking vessel 101 needs to be located.

The induction heating device 2000 according to an embodiment of the disclosure may detect whether the cooking vessel 101 including a magnetic body is placed on the top plate 1. For example, the induction heating device 2000 may detect that the cooking vessel 101 is located on the top plate 1 of the induction heating device 2000, based on a change in a current value (inductance) of a heating coil due to the approach of the cooking vessel 101.

According to an embodiment of the disclosure, the induction heating device 2000 may include a communication interface for performing communication with an external device. For example, the induction heating device 2000 may perform communication with the cooking vessel 101, with a mobile device of a user, or with a server through the communication interface. The communication interface may include a short-range communication unit (e.g., an NFC communication unit, a Bluetooth communication unit, a BLE communication unit, etc.), a mobile communication unit, and the like.

According to an embodiment of the disclosure, the induction heating device 2000 may detect the cooking vessel 101 located on the top plate 1, through the communication interface. For example, the induction heating device 2000 may detect the cooking vessel 101 by receiving a packet transmitted from the cooking vessel 101 located on the top plate 1 by using short-range wireless communication (e.g., BLE mesh network or Bluetooth).

According to an embodiment of the disclosure, even in a case in which the cooking vessel 101 does not include a communication interface, the induction heating device 2000 may detect whether the cooking vessel 101 is placed on the top plate 1 of the induction heating device 2000, through a vessel detection coil (vessel detection sensor).

According to an embodiment of the disclosure, the induction heating device 2000 may display information related to the cooking vessel 101 through a user interface. For example, when the cooking vessel 101 is detected, the induction heating device 2000 may display identification information of the cooking vessel 101 and location information of the cooking vessel 101, on a display 2411 included in the user interface.

Referring to FIG. 1A, when the user places the cooking vessel 101 (e.g., a pot) on the top plate 1 of the induction heating device 2000, the induction heating device 2000 may provide the user with identification information (e.g., ‘pot’) of the cooking vessel 101 and location information (e.g., ‘located on the left rear heating zone’) of the cooking vessel 101, as an output interface on a display 2411.

FIG. 1B is a diagram illustrating an any-place induction heating device according to an embodiment of the disclosure.

As illustrated in FIG. 1B, the induction heating device 2000 includes the top plate 1 on which an object to be heated is placed, a plurality of heating coils 2 for heating the object to be heated, an inverter circuit 3 for supplying an alternating current to the heating coils 2, and a controller 4 for controlling the inverter circuit 3.

The top plate 1 has, on the outer surface thereof, a flat surface on which an object to be heated is placed, and may be made of an electrical insulating material such as glass or ceramic.

The heating coils 2 are arranged on the back surface (lower side) of the top plate 1. As illustrated in FIG. 1B, the plurality of heating coils 2 may be arranged to form a two-dimensional array (vertical and horizontal matrix). When a current is caused to flow through the heating coils 2, a magnetic flux directed toward the top plate 1 may be generated, and an eddy current may be generated on the surface of the object to be heated placed on the top plate 1, such that the object to be heated is inductively heated.

The plurality of heating coils 2 are thin coils in the form of sheets installed on a board, and in detail, is a result of printing a copper foil on a printed board (a coil board 20) made of a photoresist or the like. Here, each of the plurality of heating coils 2 is illustrated as having the same shape and size, but the shape and size of each of the plurality of heating coils 2 may be appropriately changed. In addition, the detailed configuration of the coil board 20 will be described below.

The inverter circuit 3 is a circuit that converts an alternating-current voltage supplied from a power source into a driving frequency and outputs it to the plurality of heating coils 2. The inverter circuit 3 is a full-bridge type using switching elements, but a half-bridge type may also be used. The inverter circuit 3 may be an insulated-gate bipolar transistor (IGBT) or a field-effect transistor (FET), but is not limited thereto.

The controller 4 includes a central processing unit (CPU), memory, an input unit, and the like, and functionally, the CPU or its peripheral devices may cooperate to control the inverter circuit 3 according to a program stored in the memory.

FIG. 1C is a diagram illustrating heating coils in an any-place induction heating device, according to an embodiment of the disclosure.

Referring to FIG. 1C, the heating coils 2 of the induction heating device 2000 are made of Litz wires wound into a circle and densely arranged under the top plate 1 of the induction heating device 2000 such that there is no lack of heating regardless of where the cooking vessel 101 is placed. The induction heating device 2000 as illustrated in FIG. 1C is an any-place induction heating device described above. In the induction heating device illustrated in FIG. 1C, the heating coils 2 are arranged such that there is no blind spot between the plurality of heating coils. In addition, at least one vessel detection coil may also be arranged where the heating coils 2 are placed. In exemplary embodiments, the vessel detection coil is arranged as close to the top plate 1 as possible, and thus may be arranged on the uppermost layer from among a plurality of pattern layers included in the coil board 20. In an embodiment of the disclosure, a temperature sensor 2600 for sensing the temperature of the cooking vessel 101 may be arranged in the center of the heating coil 2. The temperature sensor 2600 according to an embodiment of the disclosure may be arranged in a hole that vertically penetrates the coil board 20 on which the heating coils 2 are printed.

FIG. 1D is a circuit diagram of an induction heating device including an inverter circuit for operating a plurality of heating coils, according to an embodiment of the disclosure. Referring to FIG. 1D, an input power source 2211 is an alternating-current power source. An alternating-current voltage of the input power source 2211 may be provided to a rectifier circuit 2112 through an electromagnetic interference (EMI) filter 2111. A plurality of diodes may be used to form the rectifier circuit 2112, as an element for converting alternating-current voltage into a direct-current voltage. In the illustrated embodiment, a diode is used as an element of the rectifier circuit 2112, but other types of switching elements capable of switching control, such as thyristors or IGBTs, may also be used. When an alternating-current voltage is converted into a direct-current voltage through the rectifier circuit 2112, the direct-current voltage may be smoothed by DC link capacitors 2117_1 and 2117_2.

FIG. 1D illustrates two resonant circuits assuming a case in which there are two heating coils 2_1 and 2_2, but in a case in which there are three heating zones and thus three heating coils are necessary, additional resonant circuits may be added. In addition, the circuit according to FIG. 1D may be applied to a case in which there are a plurality of heating coils, for example, three or more heating coils.

The direct-current voltage smoothed by the DC link capacitor 2117_1 generates a magnetic field in the first heating coil 2_1 due to resonance between the first heating coil 2_1, and a resonant capacitor 1 2114_1 and a resonant capacitor 2 2114_2 through a switching operation of two switch elements SW1 2113_1 and SW2 2113_2. The magnetic field generated in the first heating coil 2_1 generates an eddy current in the cooking vessel placed on the first heating coil 2_1, thereby heating the contents of the cooking vessel. CT1 2115_1 is a current sensor for detecting a current flowing through the first heating coil 2_1.

Similarly, the direct-current voltage smoothed by the DC link capacitor 2117_2 on the lower side generates a magnetic field in the second heating coil 2_2 due to resonance between the second heating coil 2_2, and a resonant capacitor 3 2114_3 and a resonant capacitor 4 2114_4 through a switching operation of two switch elements SW3 2113_3 and SW4 2113_4. The magnetic field generated in the second heating coil 2_2 generates an eddy current in the cooking vessel placed on the second heating coil 2_2, thereby heating the contents of the cooking vessel. CT2 2115_2 is a current sensor for detecting a current flowing through the second heating coil 2_2.

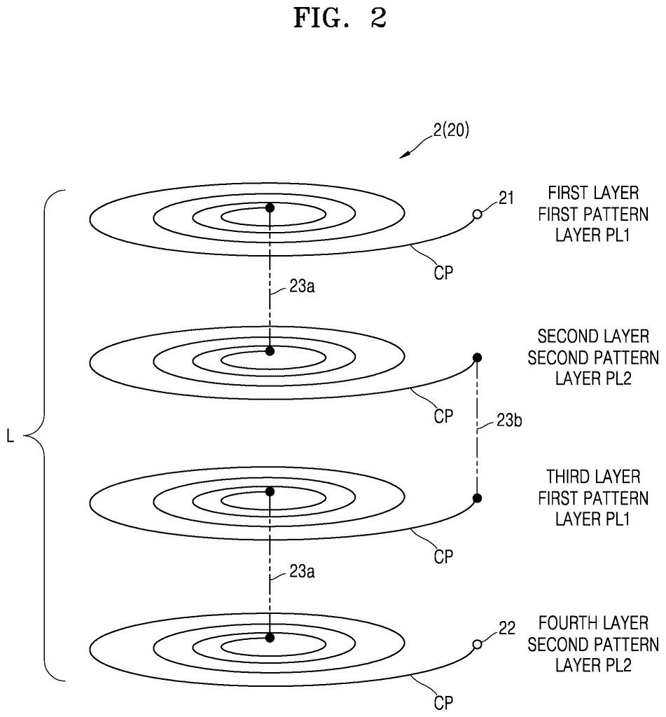

FIG. 2 is a diagram illustrating a stack structure of a coil board according to an embodiment of the disclosure.

As illustrated in FIG. 2, the coil board 20 includes an input terminal 21 into which alternating-current power is input from the inverter circuit 3, an output terminal 22 connected to a resonant capacitor or the like, and current path patterns L of a plurality of lines connecting to the input terminal 21 and the output terminal 22.

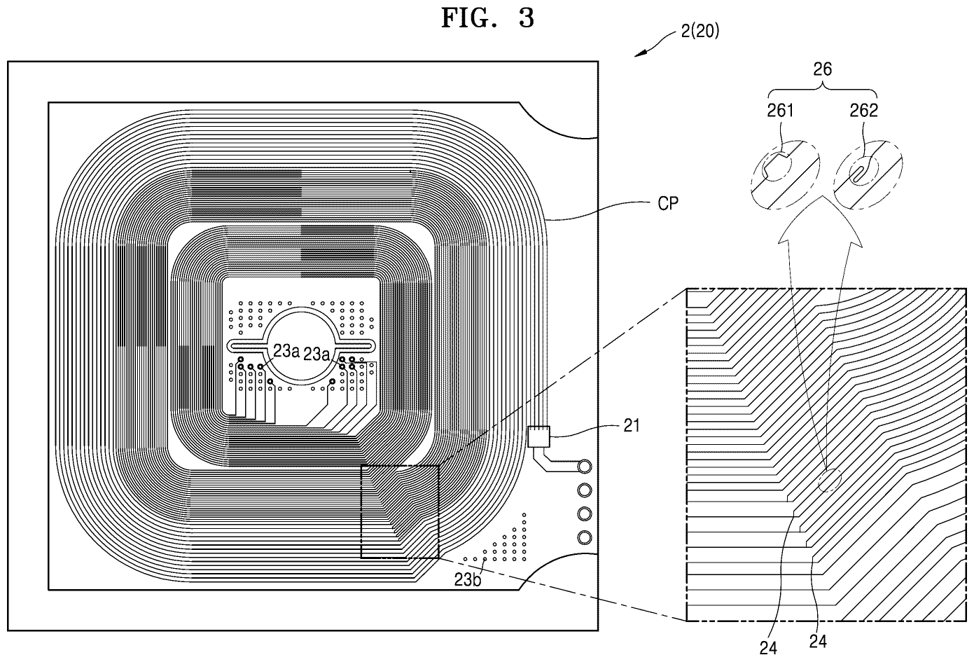

As illustrated in FIGS. 2 and 3, the coil board 20 is a printed board formed by stacking a plurality of pattern layers (here, four layers) on which coil patterns CP are formed. This is only an example and more pattern layers may be used. As illustrated in FIG. 2, the heating coil 2 may include a plurality of coil patterns CP that are formed to coaxially overlap each other. In addition, according to an embodiment of the disclosure, the coil patterns CP do not need to all coaxially overlap each other, and may overlap each other in an offset manner.

In addition, each pattern layer may be insulated by an insulating material installed between layers, and may be electrically connected by conductors 23a and 23b (through holes) installed on the inner part and/or outer part of the coil pattern CP.

In the disclosure, the plurality of stacked pattern layers will be referred to as a first layer, a second layer, a third layer, and a fourth layer in order from the top plate 1.

According to an embodiment of the disclosure, as illustrated in FIG. 2, four pattern layers are sequentially connected, from the first layer to the fourth layer. The input terminal 21 is installed on the outer part of the first-layer coil pattern CP, and the output terminal 22 is installed on the outer part of the fourth-layer coil pattern CP.

The pattern layers are classified into two types: a first pattern layer PL1 and a second pattern layer PL2.

The first pattern layer PL1 is connected to another pattern layer at the inner part of the coil pattern CP. The second pattern layer PL2 is connected to another pattern layer at the outer part of the coil pattern CP.

According to an embodiment of the disclosure, the first layer and the third layer are configured to be first pattern layers PL1, and the second layer and the fourth layer are configured to be second pattern layers PL2.

The first-layer (third-layer) coil pattern CP, which is the first pattern layer PL1, and the second-layer (fourth-layer) coil pattern CP, which is the second pattern layer PL2 connected to the first-layer (third-layer) output terminal, may be connected in series through a conductor 23a formed on the inner part of each coil patterns CP. According to an embodiment of the disclosure, the conductor 23a may include a through hole or a via hole that vertically penetrates at least one of the plurality of pattern layers when included in the printed board.

In addition, the second-layer coil pattern CP, which is the second pattern layer PL2, and the three-layer coil pattern CP, which is the first pattern layer PL1 connected to the second-layer output terminal, are connected in series through a conductor 23b formed on the outer part of each coil patterns CP. According to an embodiment of the disclosure, the conductor 23b may be a through hole or a via hole included in the printed board.

As illustrated in FIG. 2, in the current path patterns L, the coil patterns CP of the respective pattern layers may be connected in series through the conductors 23. In addition, in FIG. 2, the current path patterns L of the plurality of lines may be integrated into one line, but are not limited thereto. In other words, the current path patterns L may be a plurality of lines.

FIG. 3 is a plan view illustrating a configuration of a coil board according to an embodiment of the disclosure.

As illustrated in FIG. 3, the coil pattern CP may be formed in a plurality of parallel lines in each pattern layer. The coil pattern CP according to an embodiment of the disclosure may have a spiral shape. A plurality of spiral shapes may circle around a common center without overlapping each other. In addition, as illustrated in FIG. 2, the coil pattern CP may be formed with a plurality of coil elements that form a roughly rectangular shape when viewed from above, or may be formed with a plurality of coil elements that form a circle when viewed from above, and the shape of the coil elements is not limited thereto.

The number of turns of the coil pattern CP according to an embodiment of the disclosure is 7, but the number of turns may be appropriately changed depending on the specifications of the induction heating device 2000.

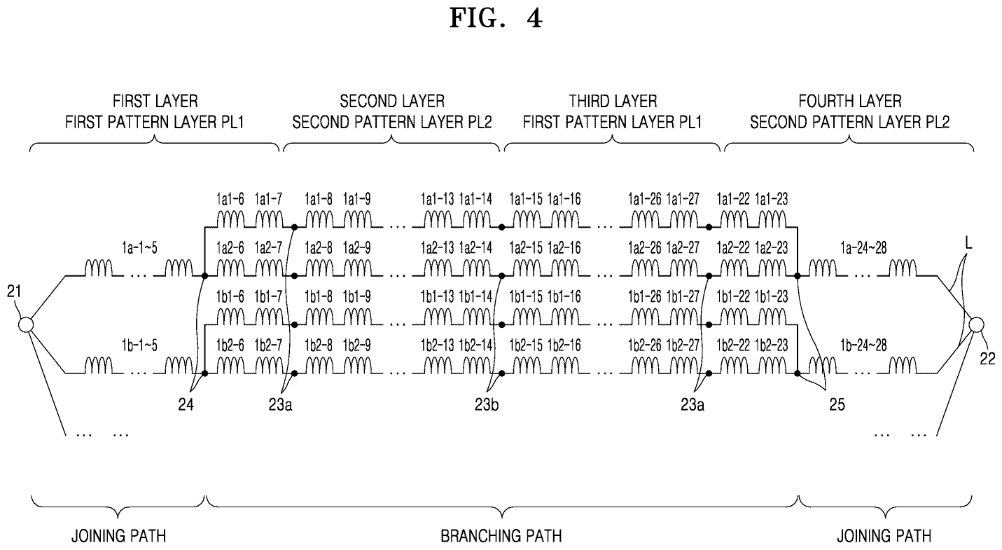

According to an embodiment of the disclosure, as illustrated in FIGS. 3 and 4, the current path pattern L may be partially or entirely branched from a point between the input terminal 21 and the output terminal 22, and join at a certain point (a joining point 25) between a branching point 24 and the output terminal 22. In addition, among the entire current path pattern L, the path from the branching point 24 to the joining point 25 is referred to as a branching path, and the other path is referred to as a joining path.

According to an embodiment of the disclosure, the branching point 24 may be provided in the first layer (the first pattern layer PL1) of the four pattern layers of the coil board 20, and the joining point 25 may be provided in the fourth layer (the second pattern layer PL2). Hereinafter, the branching point 24, the joining point 25, the branching path, and the joining path will be described in detail.

The branching point 24 and the joining point 25 according to an embodiment of the disclosure may be located in an intermediate portion between the inner part and the outer part of the coil pattern CP of the first layer (the first pattern layer PL1) or the fourth layer (the second pattern layer PL2), respectively. This is only an example, and the branching point 24 and the joining point 25 may be arranged in different pattern layers.

Here, the intermediate portion refers to an intermediate portion of the spiral shape of the coil pattern CP of the pattern layer, and may be, for example, a turn other than the innermost turn or the outermost turn from among all turns of the coil pattern CP. For example, in a case in which the coil pattern CP has 10 turns, the intermediate portion may be the fourth to sixth turn from the outside. In addition, the positions of the intermediate portions of the first pattern layer PL1 and the second pattern layer PL2 may be different from each other.

As illustrated in FIGS. 3 and 4, in the current path pattern L as a coil pattern according to an embodiment of the disclosure, five parallel branching paths 1a, 1b, . . . , 1e are formed at the input terminal 21. Each branching path is branched into two paths at the branching points 24, such that a total of ten branching paths 1a1, 1a2, 1b1, 1b2, . . . , 1e2 are provided in parallel. In FIG. 4, the third, fourth, and fifth current path patterns L (1c, 1d, and 1e) are omitted.

According to an embodiment of the disclosure, a joining path and a branching path are installed on the first layer, which is the uppermost layer, and the fourth layer, which is the lowermost layer, but branching paths may be provided on the second layer and the third layer, which are intermediate layers. However, this is only an example, and joining paths may be provided on the second layer and the third layer.

As described above, the total number of turns of the coil pattern CP of each pattern layer is 7, and in each current path pattern L (1a, 1b, and the like) of FIG. 4, the number after the hyphen (-) represents the cumulative number of turns of the coil pattern CP counted from the side of the input terminal 21.

In one embodiment, the branching point 24 is installed between the third turn and the fourth turn from the outer circumference of the coil pattern CP of the first layer (the first pattern layer PL1), and the joining point 25 is installed between the third turn and the fourth turn from the outer circumference of the coil pattern CP of the fourth layer (the second pattern layer).

Each of two branching paths installed between one branching point 24 and one joining point 25 may include a branching coil. The lengths of the branching paths are equivalent to each other or approximately the same within a certain length. In detail, that the lengths of the branching paths are equivalent to each other may mean that the difference between the lengths of two branching paths is 5% or less. In addition, in a case in which a high-frequency current of 50 kHz or higher is supplied to the heating coil 2, the difference between the lengths of two branching paths may be 1% or less. Although FIGS. 3 and 4 illustrate that one coil pattern branches into two branching paths, the configuration of the branching path according to an embodiment of the disclosure is not limited thereto. According to an embodiment of the disclosure, the number of branching paths branching from one coil pattern may be three or greater. For example, there may be three or four branching paths branching from one coil pattern. Thus, in a case in which the number of branching paths is four, four branching paths are formed.

According to an embodiment of the disclosure, in order for the lengths of branching paths to be equivalent to each other, the arrangements of the respective branching paths may be different from each other in each of a plurality of stacked pattern layers. In detail, the arrangement order of the respective branching paths may be reversed in the first pattern layer PL1 and the second pattern layer PL2. For example, in a case in which, in the first pattern layer PL1, the branching paths are arranged in the order of 1a1, 1a2, 1b1, b2, . . . , 1e2 from the outside of the coil pattern CP, the branching paths in the second pattern layer PL2 may be arranged in the order of 1e2, 1e1, 1d2, 1d1, . . . , 1a1 from the outside of the coil pattern CP.

In addition, according to an embodiment of the disclosure, an adjustment path (26) for adjusting the length of the current path pattern L may be included in the inner part of the coil pattern CP. According to an embodiment of the disclosure, the adjustment path may also be included in the outer part of the coil pattern CP. Referring to FIG. 3, the adjustment path (261, 262) may be used to extend the length of one path of two branching paths to make each length of the two branching paths be the equal or substantially the same. The pattern of the adjustment path (26) may be used in a different way to extend the length of at least one of the branching paths.

In exemplary embodiments, the width of the branching path is less than the width of the coil pattern into which the branching path joins. In detail, according to an embodiment of the disclosure, the sum of the widths of a plurality of branching paths branching from one coil pattern may be equivalent to the width of one coil pattern before branching (or after joining), but is not limited thereto. In detail, that the widths are equivalent to each other may mean that the difference between the sum of the widths of the plurality of branching paths and the width of the coil pattern after joining is about +1%.

According to the induction heating device 2000 according to an embodiment of the disclosure, the coil pattern may be branched in parallel to reduce the flowing current in a part where the alternating-current resistance of the coil pattern CP increases, so as to reduce coil loss and simultaneously prevent heat generation biased toward the corresponding coil pattern when the coil pattern is not branched.

Without branching paths, the proximity effect may be significant, which may increase the alternating-current resistance within the coil pattern. In addition, because a branching path is provided in the inner part of the coil pattern where heat is likely to accumulate, the effect of reducing loss due to the branching path may be further increased while suppressing overheating of the inner part.

In the heating coil 2 according to an embodiment of the disclosure, a plurality of coil patterns may coaxially overlap each other, and because the magnetic flux density in the inner parts or the outer parts of the coil patterns increases because the heating coil patterns overlap each other, the branching path branching as described above may reduce loss or suppress overheating.

In addition, because branching paths are installed in the intermediate layers (the third layer and the fourth layer) where heat is more likely to accumulate than in the uppermost layer (the first layer) and the lowermost layer (the fourth layer) from among the plurality of stacked pattern layers, overheating of the intermediate layers may be suppressed. Thus, according to an embodiment of the disclosure, from among the plurality of pattern layers, the pattern layer that includes at least a portion of the coil pattern branching in parallel at the branching point 24 may be the pattern layer other than the uppermost layer and the lowermost layer of the plurality of pattern layers.

According to an embodiment of the disclosure, the branching point 24 is provided in the first pattern layer PL1 (the first layer), and the joining point 25 is provided in the second pattern layer PL2 (the fourth layer), which is arranged closer to the output terminal 22 than the first layer, and thus, the branching path may be provided biased toward the inner part of the coil pattern CP. When the branching path is provided in the inner part, the current flowing in the inner part where heat tends to accumulate due to the proximity effect, may be reduced, and thus, loss may be effectively reduced while suppressing overheating of the inner part. In addition, the lifespan of the heating coil may be extended by achieving thermal balancing between the inner part where heat easily accumulates, and the outer part where heat accumulates more hardly than in the inner part.

In addition, because the lengths of the branching paths branching from one branching point 24 are equivalent to each other, the impedances of the respective branching paths may be aligned.

Because the width of the branching path is less than the width of the joining path, the coil loss due to the skin effect may be reduced, and local heating of the corresponding part may be prevented when there is no branching path.

In the above example, the current path pattern L branches in the first pattern layer and joins in the second pattern layer, but an embodiment of the disclosure is not limited thereto. The current path pattern L may branch in the second pattern layer or may join in the first pattern layer. It is enough that, the current path pattern L branches in a part where the alternating-current resistance is high such that the current flowing in the branching path becomes smaller.

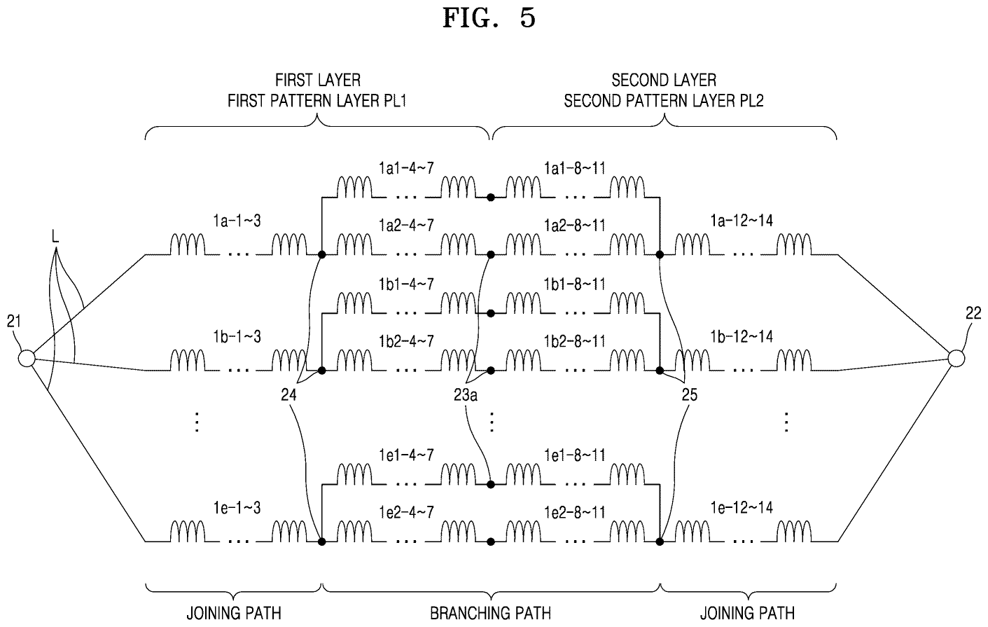

The coil board 20 according to an embodiment of the disclosure is formed by stacking four pattern layers, but the number of stacked pattern layers may be two as illustrated in FIG. 5, and it is enough that the number of stacked pattern layers is two or greater.

In the above example, intermediate layers (the second layer and the third layer) in which no branching point 24 or joining point 25 is installed are arranged between the first layer (the first pattern layer PL1) in which the branching point 24 is installed, and the fourth layer (the second pattern layer PL2) in which the joining point 25 is installed, but these intermediate layers may be composed of a plurality of pattern layers.

In addition, in a case of stacking three or more pattern layers, one or more pattern layers may be installed closer to the input terminal than the first pattern layer PL1 where the branching point 24 is installed, or closer to the output terminal than the second pattern layer PL2 where the joining point 25 is installed. Thus, according to an embodiment of the disclosure, a pattern layer in which no branching path is installed may be stacked. In a case in which a branching path is installed in any one of the plurality of stacked pattern layers, the coil loss may be reduced.

The branching path according to an embodiment of the disclosure is located at the inner part of the coil pattern CP, but may be located at the outer part. The magnetic flux is also concentrated in the outer part of the heating coil, and because the alternating-current resistance increases due to the proximity effect, by branching the current path pattern L in parallel in the outer part of the coil pattern CP to reduce the flowing current, the coil loss mat be reduced, and simultaneously, the corresponding part may be prevented from generating heat biasedly.

The current path pattern L according to an embodiment of the disclosure is designed to have five joining paths and ten branching paths, but the number of paths connected to the input terminal 21 and the output terminal 22 and the number of branching paths branching at the branching point 24 may be appropriately changed. In detail, the current path pattern L may branch into three or more paths at the branching point 24.

According to an embodiment of the disclosure, the plurality of current path patterns L branch simultaneously in an intermediate portion of the same pattern layer and join together simultaneously in another pattern layer. However, the current paths may branch or join independently of each other. For example, the current paths may branch or join in different pattern layers. When the current path pattern L branches at a point where the alternating-current resistance of the coil board 20 is high, the coil loss may be suppressed while preventing a part of the coil from generating heat biasedly.

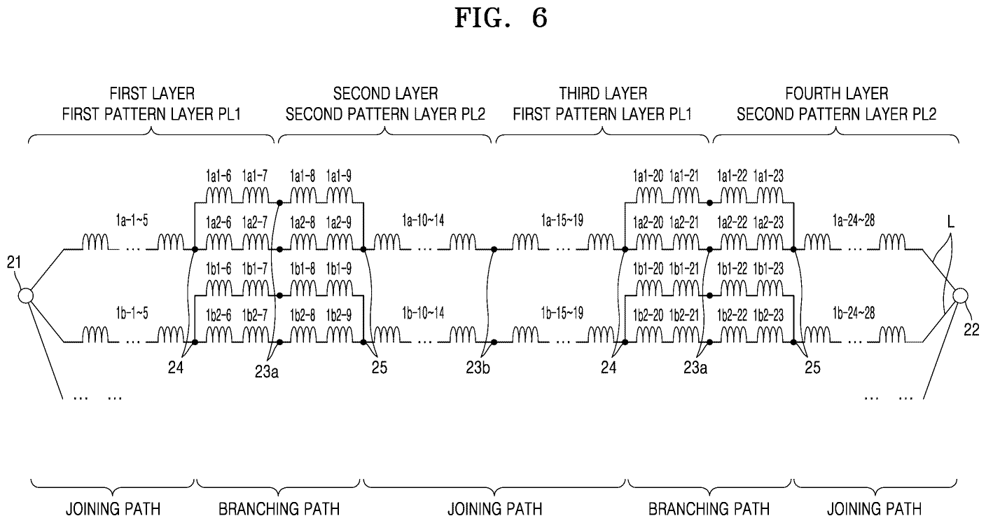

According to an embodiment of the disclosure, each current path pattern L branches and joins once between the input terminal 21 and the output terminal 22, but branching and joining may be repeated multiple times between the input terminal 21 and the output terminal 22. For example, as illustrated in FIG. 6, the current path pattern L may branch and join twice, such that it branches in an intermediate portion of the first layer (the first pattern layer PL1), joins in an intermediate portion of the second layer (the second pattern layer PL2), branches again in an intermediate portion of the third layer (the first pattern layer PL1), and joins again in the fourth layer (the second pattern layer PL2). This is only an example, and the current path pattern L may branch and join a plurality of times. According to an embodiment of the disclosure, at least a portion of the coil pattern may branch in parallel at a plurality of branching points located between the input terminal 21 and the output terminal 22, as many times as the number of branching points. In addition, at least a portion of the coil patterns may join at a plurality of joining points located between the input terminal 21 and the output terminal 22, as many times as the number of joining points.

For example, in a case in which four or more pattern layers are stacked, and the current path pattern L is configured to branch in each first pattern layer PL1 and then join in the second pattern layer PL2 on the side of the output terminal 22 (the lower side), a branching path may be installed in the inner part of the coil pattern CP of each pattern layer. In this way, the current flowing through the inner part may be significantly reduced to reduce losses, such that balancing between the inner part where heat easily accumulates and the outer part where heat accumulates more hardly than in the inner part, and thus, the lifespan of the coil may be extended.

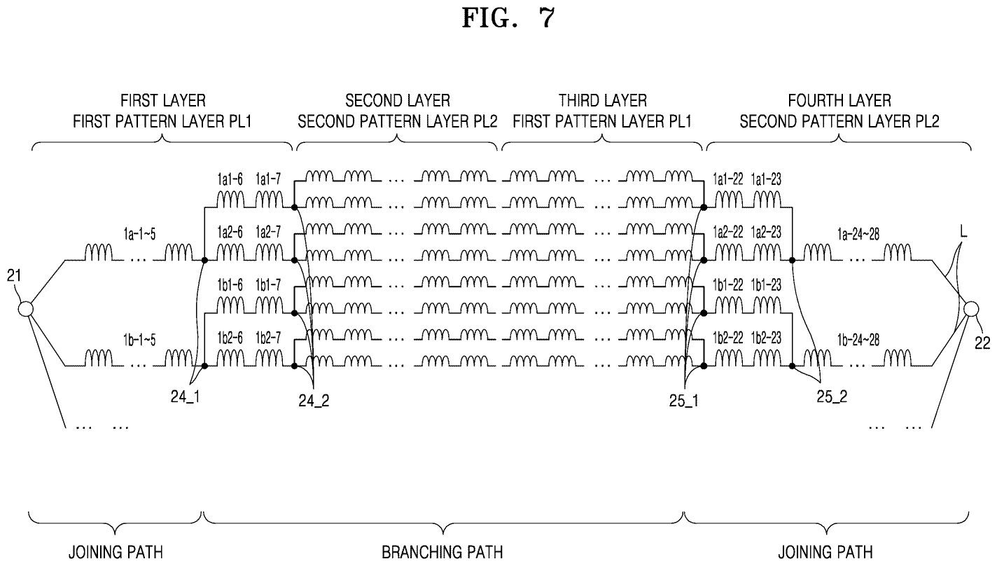

In addition, the current path pattern L that has branched once may further branch. This is illustrated in FIG. 7.

FIG. 7 is a diagram illustrating a modified example of wiring of a coil board including a plurality of branches and junctions, according to an embodiment of the disclosure.

According to an embodiment of the disclosure, for example, in a case in which four or more pattern layers are stacked, the intermediate pattern layers (the second layer and the third layer) from among the pattern layers may be more vulnerable in terms of heat generation than the uppermost layer (the first layer) or the lowermost layer (the fourth layer). Thus, for example, the current path pattern L may branch first at a first branching point 24_1 in the first layer from among the four pattern layers, and branch second at a second branching point 24_2 in the second layer. In addition, the current path pattern L may join first at a first joining point 25_1 of the third layer from among the four pattern layers, and join second at a second joining point 25_2 of the fourth layer. FIG. 7 illustrates that the current path pattern L branches and joins twice, but this is only an embodiment of the disclosure, and the current path pattern L may branch and join twice or more. In addition, FIG. 7 illustrates that the plurality of pattern layers include four layers, but the number of layers may be four or greater.

According to an embodiment of the disclosure, the input terminal 21 is installed in the first layer that is on the side of the top plate 1, and the output terminal 22 is installed in the fourth layer, which is the lowermost layer, but the arrangement of the input terminal 21 and the output terminal 22 may be reversed.

According to an embodiment of the disclosure, the four pattern layers are connected in the order of proximity to the top plate 1, from the first layer to the fourth layer, but the connection order of each pattern layer may be appropriately changed. In detail, the pattern layers may be connected in the order of the first layer→the second layer→the third layer→the fourth layer between the input terminal 21 and the output terminal 22. In this case, the first layer and the third layer are first pattern layers PL1, and the second layer and the fourth layer are second pattern layers PL2.

The coil board according to an embodiment of the disclosure may be used in a non-contact power supply device.

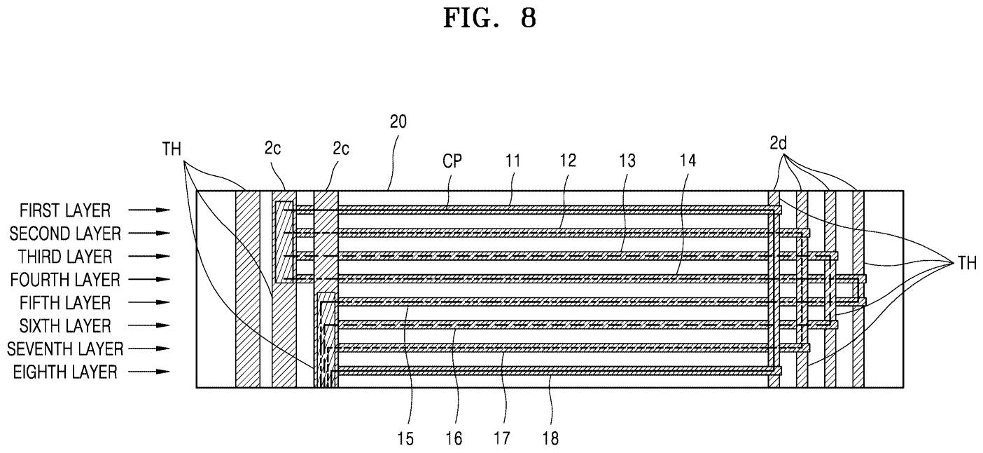

FIG. 8 is a cross-sectional view illustrating interlayer connections of a coil board according to an embodiment of the disclosure.

FIG. 8 is a cross-sectional view illustrating interlayer connections in an eight-layer coil board 20, according to an embodiment of the disclosure. Referring to FIG. 8, the coil board 20 may be a PCB formed by stacking four or more pattern layers PL on which coil patterns CP are formed. An insulating layer on which two or more prepreg insulating layers are stacked may be arranged between the pattern layers.

FIG. 8 illustrates the coil board 20 formed by stacking a plurality of pattern layers including eight layers (first to eighth layers), according to an embodiment of the disclosure. According to an embodiment of the disclosure, the coil board 20 includes coil patterns 11, 12, 13, and 14 in four layers, and coil patterns 15, 16, 17, and 18 in four layers. In an embodiment of the disclosure, the coil patterns 11, 12, 13, and 14 in four layers may have four coil patterns CP connected in series, respectively. The coil patterns 11, 12, 13, and 14 in four layers may be connected to each other via through holes 2c or via holes.

In FIG. 8, assume that a plurality of pattern layers 11, 12, . . . , 18 are, from the top, a first-layer coil pattern 11, a second-layer coil pattern 12, a third-layer coil pattern 13, a fourth-layer coil pattern 14, a fifth-layer coil pattern 15, a sixth-layer coil pattern 16, a seventh-layer coil pattern 17, and an eighth-layer coil pattern 18.

As illustrated in FIG. 8, the first-layer coil pattern 11 may be connected in series to the eighth-layer coil pattern 18 formed on the eighth layer, through a through hole 2d. The second-layer coil pattern 12 may be connected in series to the seventh-layer coil pattern 17 formed on the seventh layer, through a through hole 2d. The third-layer coil pattern 13 may be connected in series to the sixth-layer coil pattern 16, through a through hole 2d. The fourth-layer coil pattern 14 may be connected in series to the fifth-layer coil pattern 15, through a through hole 2d.

As such, the plurality of upper pattern layers 11, 12, 13, and 14 illustrated in FIG. 8 have different combinations of pattern layers connected in series. In a case in which four pattern layers 11, 12, 13, and 14 are connected via through hole 2c, the coil patterns CP formed on different pattern layers may be connected in parallel.

In addition, in the coil board 20 according to an embodiment of the disclosure, the coil patterns CP may be connected such that the input terminal 21 is in the uppermost layer of the plurality of pattern layers, and the output terminal 22 is in the lowermost layer of the plurality of pattern layers. According to this configuration, in a case in which a low power sensor is mounted in an upper layer when forming a plurality of pattern layers, it is easy to form the low power sensor in a thin film structure. The low power sensor may include a vessel detection coil. The multilayer structure of the coil board 20 is not limited to the above-described eight-layer structure, and the number of layers of the multilayer structure may be fewer or more.

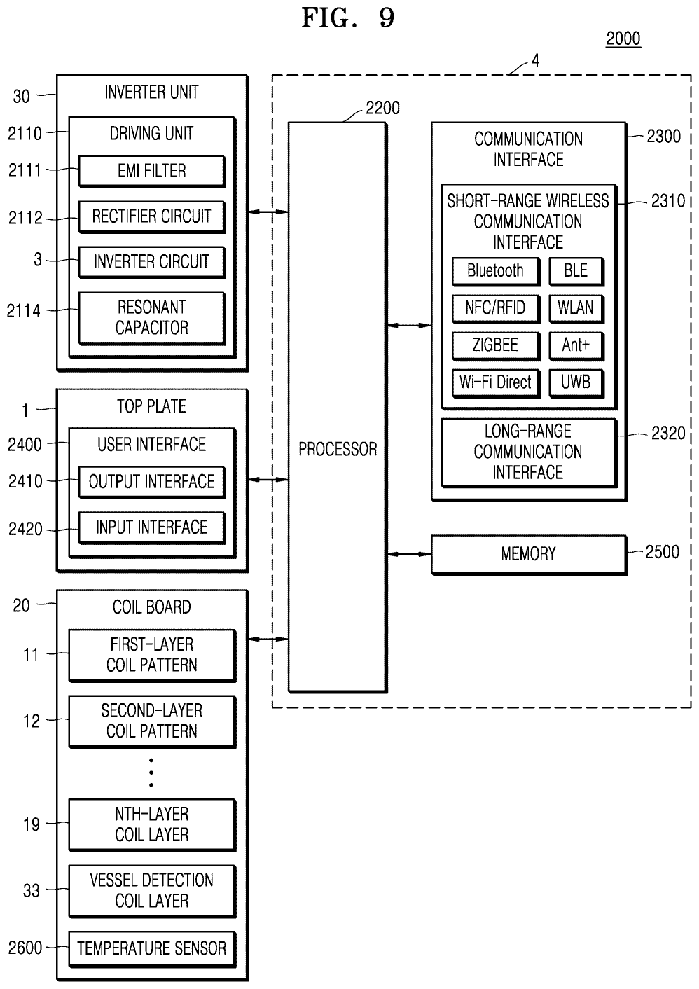

FIG. 9 is a block diagram of an induction heating device according to an embodiment of the disclosure.

As illustrated in FIG. 9, the induction heating device 2000 according to an embodiment of the disclosure may include a controller 4, an inverter unit 30, a top plate 1, and a coil board 20.

In the induction heating device 2000 according to an embodiment of the disclosure, the top plate 1 is a plate on which the cooking vessel 101 is placed, and is usually made of heat-resistant tempered glass. The top plate 1 may include a user interface 2400. The user interface 2400 may include an output interface 2410 such as a display, and an input interface 2420 such as a touch button. In an embodiment of the disclosure, the actual operation of the output interface 2410 such as a display and the input interface 2420 such as a touch button may be performed under control of a processor 2200 to be described below.

The output interface 2410 is for outputting an audio signal or a video signal, and may include a display, an audio output unit, and the like.

In a case in which a display and a touch pad constitute a layer structure to form a touch screen, the display may serve as the input interface 2420 in addition to the output interface 2410. The display may include at least one of a liquid-crystal display, a thin-film-transistor liquid-crystal display, a light-emitting diode (LED) display, an organic LED display, a flexible display, a three-dimensional (3D) display, or an electrophoretic display. In addition, depending on the design, the induction heating device 2000 may include two or more displays.

The audio output unit may output audio data received from a communication interface 2300 or stored in memory 2500. In addition, the audio output unit may output an audio signal related to a function performed by the induction heating device 2000. The audio output unit may include a speaker, a buzzer, and the like.

According to an embodiment of the disclosure, the output interface 2410 may display information about the cooking vessel 101. For example, the output interface 2410 may output a graphical user interface (GUI) corresponding to identification information or product type information of the cooking vessel 101. In addition, the output interface 2410 may output information about the current location of the cooking vessel 101 or the material of the cooking vessel 101.

The input interface 2420 is for receiving an input from the user. The input interface 2420 may be, but is not limited to, at least one of a key pad, a dome switch, a touch pad (e.g., a touch-type capacitive touch pad, a pressure-type resistive overlay touch pad, an infrared sensor-type touch pad, a surface acoustic wave conduction touch pad, an integration-type tension measurement touch pad, a piezoelectric effect-type touch pad), a jog wheel, or a jog switch.

The input interface 2420 may include a speech recognition module. For example, the induction heating device 2000 may receive, through a microphone, a voice signal, which is an analog signal, and convert a speech part into a computer-readable text by using an automatic speech recognition (ASR) model. The induction heating device 2000 may interpret the text by using a natural language understanding (NLU) model to obtain an utterance intention of the user. Here, the ASR model or the NLU model may be an artificial intelligence model. The artificial intelligence model may be processed by an artificial intelligence-dedicated processor designed in a hardware structure specialized for processing an artificial intelligence model. The artificial intelligence model may be generated via a training process. Here, being generated via a training process may mean that predefined operation rules or artificial intelligence model set to perform desired characteristics (or purposes), is generated by training a basic artificial intelligence model by using a learning algorithm that utilizes a large amount of training data. The artificial intelligence model may include a plurality of neural network layers. Each of the neural network layers has a plurality of weight values, and performs a neural network arithmetic operation via an arithmetic operation between an arithmetic operation result of a previous layer and the plurality of weight values.

Linguistic understanding is a technology for recognizing and applying/processing human language/characters, and includes natural language processing, machine translation, dialogue system, question answering, speech recognition/synthesis, and the like.

In the induction heating device 2000 according to an embodiment of the disclosure, the coil board 20 may include a plurality of pattern layers, for example, the first-layer coil pattern 11, the second-layer coil pattern 12, . . . , an nth-layer coil pattern 19 (n is a natural number greater than or equal to 2). The first-layer coil pattern 11, the second-layer coil pattern 12, . . . , the nth-layer coil pattern 19 may include a heating coil printed and patterned on a PCB. The coil board 20 may have a structure in which the first-layer coil pattern 11, the second-layer coil pattern 12, . . . , the nth-layer coil pattern 19 are stacked, and through this, heating coils constitute a plurality of heating coils 2.

The plurality of heating coils 2 patterned on the coil board 10 may generate a magnetic field for heating the cooking vessel 101. For example, when a current is supplied to the plurality of heating coils 2, a magnetic field may be induced around the plurality of heating coils 2. When a current that changes in magnitude and direction over time, i.e., an alternating current, is supplied to the plurality of heating coils 2, a magnetic field that changes in magnitude and direction over time may be induced around the plurality of heating coils 2. The magnetic field around the plurality of heating coils 2 may pass through the top plate 1 made of tempered glass and reach the cooking vessel 101 placed on the top plate 1. An eddy current rotating around the magnetic field may be generated in the cooking vessel 101 due to the magnetic field that changes in magnitude and direction over time, and resistance heat may be generated in the cooking vessel 101 due to the eddy current. Resistance heat is heat generated in a resistor when a current flows therethrough, and is also referred to as Joule heat. The cooking vessel 101 is heated by the electrical resistance heat, and thus, the contents of the cooking vessel 101 may be heated.

In the induction heating device 2000 according to an embodiment of the disclosure, the coil board 20 may further include the temperature sensor 2600. The temperature sensor 2600 may sense the temperature of the top plate 1 or the cooking vessel 101 placed on the top plate 1. The processor 2200 may determine whether the cooking vessel 101 is being empty-heated or overheated, based on the temperature of the cooking vessel 101 sensed by the temperature sensor 2600. In an embodiment of the disclosure, the temperature sensor 2600 may be installed in a hole penetrating the coil board 20.

The coil board 20 of the induction heating device 2000 according to an embodiment of the disclosure may further include a vessel detection coil layer 33. In an embodiment of the disclosure, the vessel detection coil layer 33 may include a vessel detection coil. In an embodiment of the disclosure, the vessel detection coil may be printed on a PCB in a pattern form, as part of the first-layer coil pattern 11. The processor 2200 of the induction heating device 2000 may detect whether the cooking vessel 101 is placed on the top plate 1 of the induction heating device 2000, through the vessel detection coil included in the vessel detection coil layer 33 or the first-layer coil pattern 11.

The inverter unit 30 may include a driving unit 2110. The driving unit 2110 may receive power from an input power source and supply a current to the plurality of heating coils 2 according to a driving control signal of the processor 2200. The driving unit 2110 may include, but is not limited to, the EMI filter 2111, the rectifier circuit 2112, the inverter circuit 3, and a resonant capacitor 2114.

The EMI filter 2111 may filter out high-frequency noise included in an alternating-current voltage supplied from the input power source, and pass an alternating-current voltage and an alternating current with a predefined frequency (e.g., 50 Hz or 60 Hz). A fuse and a relay for blocking an overcurrent may be provided between the EMI filter 2111 and the input power supply. The alternating-current voltage from which high-frequency noise is filtered out by the EMI filter 2111 is supplied to the rectifier circuit 2112.

The rectifier circuit 2112 may convert the alternating-current voltage into a direct-current voltage. For example, the rectifier circuit 2112 may convert an alternating-current voltage that changes in magnitude and polarity (i.e., positive voltage or negative voltage) over time, into a direct-current voltage with a constant magnitude and polarity, and may convert an alternating current that changes in magnitude and direction (i.e., positive current or negative current) over time, into a direct current that does not change in polarity over time. The rectifier circuit 2112 may include a diode as an element for rectification. For example, the rectifier circuit 2112 may include four diodes. The diode may convert an alternating-current voltage that changes in polarity over time, into a positive voltage with a constant polarity, and may convert an alternating current that changes in direction over time, into a positive current with a constant direction. The rectifier circuit 2112 may be connected to a DC link capacitor that smooths the rectified direct-current voltage.

The inverter circuit 3 may include a switching circuit that supplies or blocks a driving current to the plurality of heating coils 2. The inverter circuit 3 may cause resonance between the plurality of heating coils 2 and the resonant capacitor 2114 through a switching operation of the switching circuit. According to an embodiment of the disclosure, the induction heating device 2000 may include a separate driving processor in addition to the processor 2200, for generating a driving control signal to be provided to the switching element of the inverter circuit 3.

The inverter circuit 3 may control a current supplied to the plurality of heating coils 2.

In the induction heating device 2000 according to an embodiment of the disclosure, the controller 4 may include, but is not limited to, the processor 2200, the communication interface 2300, and the memory 2500. In addition, the components included in the controller 4 may be electrically connected to the components included in the inverter unit 30, the top plate 1, and the coil board 20, through connectors or the like.

The processor 2200 of the controller 4 may determine the switching frequency (i.e., a turn-on/turn-off frequency) of the switching circuit included in the inverter circuit 3 based on the output strength (i.e., the power level) of the induction heating device 2000. The processor 2200 may generate a driving control signal for turning on/off the switching circuit according to the determined switching frequency. The induction heating device 2000 may include a separate driving processor from the processor 2200, for controlling the operation of the driving unit 2110 including the inverter circuit 3 during the operation of the processor 2200. However, this is only an example and the operation of the driving processor may be replaced by the processor 2200.

The processor 2200 is a hardware device that controls the overall operation of the induction heating device 2000. The processor 2200 may include one processor or a plurality of processors. The processor 2200 according to an embodiment of the disclosure may be a hardware processing circuit including at least one of a CPU, a graphics processing unit (GPU), an accelerated processing unit (APU), a many-integrated core (MIC), a digital signal processor (DSP), an integrated circuit, or a neural processing unit (NPU). The processor 2200 may be implemented in the form of an integrated system on a chip (SoC) including one or more electronic components. In a case in which the processor 2200 includes a plurality of processors, each processor may be implemented as separate hardware (H/W). The processor 2200 may be referred to as a microprocessor controller (MICOM), a microprocessor unit (MPU), or a microcontroller unit (MCU). The processor 2200 according to the disclosure is a hardware device that may be implemented as a single-core processor or a multi-core processor. The processor 2200 may execute programs stored in the memory 2500 to control the components of the inverter unit 30, the communication interface 2300, the user interface 2400, the memory 2500, and the coil board 20.

According to an embodiment of the disclosure, the induction heating device 2000 may be equipped with an artificial intelligence (AI) processor. The AI processor may be manufactured in the form of a dedicated hardware chip for AI, or may be manufactured as part of an existing general-purpose processor (e.g., a CPU or an application processor) or a dedicated graphics processor (e.g., a GPU), and then mounted on the induction heating device 2000.

In a case in which unique identification information of the cooking vessel 101 is stored in the memory 2500, the processor 2200 may establish a short-range wireless communication channel (e.g., a BLE communication channel) with the cooking vessel 101 through the communication interface 2300.

The communication interface 2300 of the controller 4 may include one or more components that enable communication between the induction heating device 2000 and the cooking vessel 101, between the induction heating device 2000 and a server (not shown), or between the induction heating device 2000 and a user terminal (not shown). For example, the communication interface 2300 may include a short-range wireless communication interface 2310 and a long-range communication interface 2320. The short-range wireless communication interface 2210 may include, but is not limited to, a Bluetooth communication unit, a BLE mesh network communication unit, an NFC unit, a WLAN (e.g., Wi-Fi) communication unit, a Zigbee communication unit, an IrDA communication unit, a WFD communication unit, a UWB communication unit, an Ant+communication unit, and the like. In a case in which the cooking vessel 101 is remotely controlled by a server (not shown) in an internet-of-Things (IoT) environment, the long-range communication interface 2320 may be used to communicate with the server. The long-range communication interface 2320 may include the Internet, a computer network (e.g., a LAN or a WAN), and a mobile communication unit. The mobile communication unit transmits and receives radio signals to and from at least one of a base station, an external terminal, or a server, on a mobile communication network. Here, the radio signals may include a voice call signal, a video call signal, or various types of data according to text/multimedia message transmission and reception. The mobile communication unit may include, but is not limited to, a 3G module, a 4G module, an LTE module, a 5G module, a 6th Generation (6G) module, an NB-IoT module, an LTE-M module, and the like.

The memory 2500 may store a program for the processor 2200 to perform the operation and control of the induction heating device 2000, and may store input/output data (e.g., unique identification information of the cooking vessel 101, variable identification information of the cooking vessel 101, a plurality of power transmission patterns, cooking progress information of the cooking vessel 101, or material information of the cooking vessel 101). The memory 2500 may store a coded command regarding a switching operation for driving the inverter circuit 3. In addition, the memory 2500 may also store an AI model.

The memory 2500 may include at least one of a flash memory-type storage medium, a hard disk-type storage medium, a multimedia card micro-type storage medium, a card-type memory (e.g., SD or XD memory), random-access memory (RAM), static RAM (SRAM), read-only memory (ROM), electrically erasable programmable ROM (EEPROM), programmable ROM (PROM), magnetic memory, a magnetic disk, or an optical disc. In addition, the induction heating device 2000 may operate a web storage or a cloud server that performs a storage function on the Internet.

According to an embodiment of the disclosure, a coil board formed by stacking a plurality of pattern layers on which coil patterns are formed is formed by connecting the coil patterns in series, and may include current path patterns of a plurality of lines connecting to an input terminal and an output terminal. According to an embodiment of the disclosure, each of some or all of the current path patterns of the plurality of lines may branch in parallel at a branching point along the way from the input terminal to the output terminal. According to an embodiment of the disclosure, some or all of the current path patterns of the plurality of lines may join at a joining point between the branching point and the output terminal.

According to an embodiment of the disclosure, any one of the plurality of pattern layers may be any one of a first pattern layer that is connected to another pattern layer on the side of the output terminal through a conductor formed on the inner part of the coil pattern, or a second pattern layer that is connected to another pattern layer on the side of the output terminal through a conductor formed on the outer part of the coil pattern. According to an embodiment of the disclosure, some or all of the current path patterns may branch in a first pattern layer and join in another pattern layer.

According to an embodiment of the disclosure, the branched current path patterns may join in a second pattern layer.

According to an embodiment of the disclosure, when paths from branching points to joining points in the entire current path pattern are branching paths, the lengths of the respective branching paths branching from the same current path pattern are equivalent to each other within a predefined error range.

According to an embodiment of the disclosure, a plurality of pattern layers may be arranged between the first pattern layer having a branching point and the second pattern layer having a joining point.

According to an embodiment of the disclosure, the width of the current path pattern between branching and joining may be less than the width of the current path pattern before the branching or after the joining.

An induction heating device according to an embodiment of the disclosure may include an inverter circuit configured to drive heating coils. The induction heating device according to an embodiment of the disclosure may include a coil board including a plurality of pattern layers on which heating coils are printed to form coil patterns. According to an embodiment of the disclosure, the coil patterns respectively formed on the plurality of pattern layers may be electrically connected to each other, a first end of the coil patterns may be connected to an input terminal, and a second end of the coil patterns may be connected to an output terminal. According to an embodiment of the disclosure, at least one of the coil patterns branch in parallel at a branching point located between the input terminal and the output terminal, and join at a joining point located between the branching point and the output terminal.

In the induction heating device according to an embodiment of the disclosure, a first-layer coil pattern of the plurality of pattern layers may be electrically connected to a second-layer coil pattern of the plurality of pattern layers through a conductor formed in an inner part of the first-layer coil pattern.

In the induction heating device according to an embodiment of the disclosure, the second-layer coil pattern of the plurality of pattern layers may be electrically connected to a third-layer coil pattern through a conductor formed in an outer part of the second-layer coil pattern.

In the induction heating device according to an embodiment of the disclosure, the conductor may include a via hole vertically penetrating at least one of the plurality of pattern layers.

According to an embodiment of the disclosure, lengths of two or more branching paths branching in parallel at the branching point and joining at the joining point may be equivalent to each other within a difference of 5% or less.

According to an embodiment of the disclosure, when a frequency of a current flowing through the coil pattern is 50 kHz or greater, the lengths of the two or more branching paths may be equivalent to each other within a difference of 1% or less.

In the induction heating device according to an embodiment of the disclosure, when the branching paths, which are generated as the coil patterns formed on the plurality of pattern layers branch, are arranged such that a first branching path, a second branching path, . . . , and an nth branching path (n is a natural number greater than or equal to 2) are arranged from the inner part of the first-layer coil pattern, the first branching path, the second branching path, . . . , and the nth branching path may be arranged from the outer part of the second-layer coil pattern.

In the induction heating device according to an embodiment of the disclosure, the coil board may include an adjustment path formed in the inner part or an outer part of the first-layer coil pattern, to adjust lengths of at least one of the first branching path, the second branching path, . . . , and the nth branching path.

According to an embodiment of the disclosure, a pattern layer including at least one of the coil patterns branching in parallel at the branching point may be a pattern layer other than an uppermost layer and a lowermost layer of the plurality of pattern layers of the coil board.

In the induction heating device according to an embodiment of the disclosure, the uppermost layer, which does not include the branching point, may include the input terminal or the output terminal. According to an embodiment of the disclosure, the lowermost layer, which does not include the joining point, may include the output terminal or the input terminal.

In the induction heating device according to an embodiment of the disclosure, from among the coil patterns formed on the plurality of pattern layers, a first coil pattern may branch in a first layer of the plurality of pattern layers, and a second coil pattern may branch in a second layer of the plurality of pattern layers.

In the induction heating device according to an embodiment of the disclosure, the branching point at which at least one of the coil patterns branch in parallel may be a point at which alternating-current resistance of the coil board is higher than areas where the other coil patterns are located.

In the induction heating device according to an embodiment of the disclosure, at least one of the coil patterns may branch in parallel at a plurality of branching points located between the input terminal and the output terminal as many times as the number of the plurality of branching points, and join at a plurality of joining points located between the input terminal and the output terminal as many times as the number of the plurality of joining points.

In the induction heating device according to an embodiment of the disclosure, the coil patterns of respective layers included in the plurality of pattern layers may be electrically connected to each other in series.

In the induction heating device according to an embodiment of the disclosure, the coil patterns of respective layers included in the plurality of pattern layers may be electrically connected to each other in series or in parallel.

The coil board according to an embodiment of the disclosure may be used in an induction heating device or a non-contact power supply device.

The induction heating device according to the disclosure configured as described above may suppress coil loss when a high-frequency current is caused to flow through it, while preventing a part of a coil from generating heat biasedly.

In addition, the disclosure is not limited to the above-described embodiment, and various modifications are possible without departing from the spirit of the disclosure.

A method according to an embodiment of the disclosure may be embodied as program commands executable by various computer devices, and recorded on a computer-readable medium. The computer-readable medium may include program commands, data files, data structures, or the like separately or in combinations. The program commands to be recorded on the medium may be specially designed and configured for the disclosure or may be well-known to and be usable by those skill in the art of computer software. Examples of the computer-readable recording medium include magnetic media such as hard disks, floppy disks, or magnetic tapes, optical media such as a compact disc ROM (CD-ROM) or a digital video disc (DVD), magneto-optical media such as a floptical disk, and hardware devices such as ROM, RAM, or flash memory, which are specially configured to store and execute program commands. Examples of the program commands include not only machine code, such as code made by a compiler, but also high-level language code that is executable by a computer by using an interpreter or the like.

An embodiment of the disclosure may be implemented as a recording medium including computer-readable instructions such as a computer-executable program module. The computer-readable medium may be any available medium which is accessible by a computer, and may include a volatile or non-volatile medium and a removable or non-removable medium. Also, the computer-readable medium may include a computer storage medium and a communication medium. The computer storage media include both volatile and non-volatile, removable and non-removable media implemented in any method or technique for storing information such as computer readable instructions, data structures, program modules or other data. The communication media typically include computer-readable instructions, data structures, program modules, other data of a modulated data signal, or other transmission mechanisms, and examples thereof include an arbitrary information transmission medium. Also, some embodiments of the disclosure may be implemented as a computer program or a computer program product including computer-executable instructions such as a computer program executed by a computer.

A machine-readable storage medium may be provided in the form of a non-transitory storage medium. Here, the term ‘non-transitory storage medium’ refers to a tangible device and does not include a signal (e.g., an electromagnetic wave), and the term ‘non-transitory storage medium’ does not distinguish between a case where data is stored in a storage medium semi-permanently and a case where data is stored temporarily. For example, the ‘non-transitory storage medium’ may include a buffer in which data is temporarily stored.

According to an embodiment of the disclosure, methods according to an embodiment disclosed herein may be included in a computer program product and then provided. The computer program product may be traded as commodities between sellers and buyers. The computer program product may be distributed in the form of a machine-readable storage medium (e.g., a CD-ROM), or may be distributed online (e.g., downloaded or uploaded) through an application store or directly between two user devices (e.g., smart phones). In a case of online distribution, at least a portion of the computer program product (e.g., a downloadable app) may be temporarily stored in a machine-readable storage medium such as a manufacturer's server, an application store's server, or memory of a relay server.

What is claimed is:

1. An induction heating device comprising:
an inverter circuit configured to drive heating coils; and
a coil board comprising a plurality of pattern layers on which the heating coils are printed to form coil patterns,
wherein the coil patterns respectively formed on the plurality of pattern layers are electrically connected to each other,
a first end of the coil patterns is connected to an input terminal,
a second end of the coil patterns is connected to an output terminal, and
at least one of the coil patterns branch in parallel at a branching point located between the input terminal and the output terminal, and join at a joining point located between the branching point and the output terminal.

2. The induction heating device of claim 1, wherein a first-layer coil pattern of the plurality of pattern layers is electrically connected to a second-layer coil pattern of the plurality of pattern layers through a conductor formed in an inner part of the first-layer coil pattern.

3. The induction heating device of claim 2, wherein the second-layer coil pattern of the plurality of pattern layers is electrically connected to a third-layer coil pattern through a conductor formed in an outer part of the second-layer coil pattern.

4. The induction heating device of claim 2, wherein the conductor comprises a via hole vertically penetrating at least one of the plurality of pattern layers.

5. The induction heating device of claim 1, wherein lengths of two or more branching paths branching in parallel at the branching point and joining at the joining point are equivalent to each other within a difference of 5% or less.

6. The induction heating device of claim 5, wherein, when a frequency of a current flowing through the coil pattern is 50 kHz or greater, the lengths of the two or more branching paths are equivalent to each other within a difference of 1% or less.

7. The induction heating device of claim 5, wherein, when the branching paths, which are generated as the coil patterns formed on the plurality of pattern layers branch, are arranged such that a first branching path, a second branching path, . . . , and an nth branching path (where n is a natural number greater than or equal to 2) are arranged from the inner part of the first-layer coil pattern, the first branching path, the second branching path, . . . , and the nth branching path are arranged from the outer part of the second-layer coil pattern.

8. The induction heating device of claim 7, wherein the coil board comprises an adjustment path formed in the inner part or an outer part of the first-layer coil pattern, to adjust lengths of at least one of the first branching path, the second branching path, . . . , and the nth branching path.

9. The induction heating device of claim 1, wherein a pattern layer comprising at least one of the coil patterns branching in parallel at the branching point is a pattern layer other than an uppermost layer and a lowermost layer of the plurality of pattern layers of the coil board.

10. The induction heating device of claim 9, wherein the uppermost layer, which does not comprise the branching point, comprises the input terminal or the output terminal, and
the lowermost layer, which does not comprise the joining point, comprises the output terminal or the input terminal.

11. The induction heating device of claim 1, wherein, from among the coil patterns formed on the plurality of pattern layers, a first coil pattern branches in a first layer of the plurality of pattern layers, and a second coil pattern branches in a second layer of the plurality of pattern layers.

12. The induction heating device of claim 1, wherein the branching point at which at least one of the coil patterns branch in parallel is a point at which alternating-current resistance of the coil board is higher than areas where the other coil patterns are located.

13. The induction heating device of claim 1, wherein at least one of the coil patterns branch in parallel at a plurality of branching points located between the input terminal and the output terminal as many times as a number of the plurality of branching points, and join at a plurality of joining points located between the input terminal and the output terminal as many times as a number of the plurality of joining points.

14. The induction heating device of claim 1, wherein the coil patterns of respective layers included in the plurality of pattern layers are electrically connected to each other in series.

15. The induction heating device of claim 1, wherein the coil patterns of respective layers included in the plurality of pattern layers are electrically connected to each other in series or in parallel.

16. A coil board for an induction heating device, the coil board comprising:
an input terminal;
an output terminal; and
a plurality of pattern layers which form coil patterns,
wherein the coil patterns respectively formed on the plurality of pattern layers are electrically connected to each other, a first end of the coil patterns is connected to the input terminal, a second end of the coil patterns is connected to the output terminal, and at least one of the coil patterns branch in parallel at a branching point located between the input terminal and the output terminal, and join at a joining point located between the branching point and the output terminal.

17. The coil board of claim 16, wherein a first-layer coil pattern of the plurality of pattern layers is electrically connected to a second-layer coil pattern of the plurality of pattern layers through a conductor formed in an inner part of the first-layer coil pattern.

18. The coil board of claim 17, wherein the second-layer coil pattern of the plurality of pattern layers is electrically connected to a third-layer coil pattern through a conductor formed in an outer part of the second-layer coil pattern.

19. The coil board of claim 16, wherein lengths of two or more branching paths branching in parallel at the branching point and joining at the joining point are equivalent to each other within a difference of 5% or less.

20. The coil board of claim 16, wherein a pattern layer comprising at least one of the coil patterns branching in parallel at the branching point is a pattern layer other than an uppermost layer and a lowermost layer of the plurality of pattern layers of the coil board.
